(19) United States
(12) Patent Application Publication
(10) Pub. No.: US 2026/0022979 A1
(43) Pub. Date: Jan. 22, 2026

(54) TEMPERATURE MEASUREMENT METHOD BASED ON LASER DEFLECTION INDUCED BY ULTRASONIC PULSE

(71) Applicant: Zhejiang University, Hangzhou (CN)

(72) Inventors: Zhihua WANG, Hangzhou (CN); Wubin WENG, Hangzhou (CN); Yong HE, Hangzhou (CN); Siyu LIU, Hangzhou (CN); Yan DAI, Hangzhou (CN); Yanqun ZHU, Hangzhou (CN)

(73) Assignee: Zhejiang University, Hangzhou (CN)

(21) Appl. No.: 18/890,792

(22) Filed: Sep. 20, 2024

(30) Foreign Application Priority Data
Jul. 18, 2024 (CN) 202410969323.5

(51) Int. Cl. G01K 11/24; G01H 9/00

(52) U.S. Cl. CPC G01K 11/24; G01H 9/008

(57) ABSTRACT

The provided is a temperature measurement method based on laser deflection induced by ultrasonic pulse. The method includes the following steps: S1, emitting a continuous laser beam by a continuous laser, and collimating the laser beam by a collimator; S2, the laser beam passes through a high-temperature gas to be measured; S3, the laser beam folds back and again passes through the high-temperature gas to be measured, and then received by a quadrant photodiode; S4, arranging a pulse ultrasonic generator in a vertical direction of the laser beam, and carrying out control by an ultrasonic generator control box; S5, the ultrasonic successively passes through the laser beams at different distances from the pulse ultrasonic generator, and obtaining a generated deflection position information of the laser beams by the quadrant photodiode; S6, analyzing the voltage signal of the quadrant photodiode obtained by step S5.

### CROSS REFERENCE TO THE RELATED APPLICATIONS

This application is based upon and claims priority to Chinese Patent Application No. 202410969323.5, filed on Jul. 18, 2024, the entire contents of which are incorporated herein by reference.

### TECHNICAL FIELD

The present invention relates to the field of ultrasonic technology, in particular to a temperature measurement method based on a laser deflection induced by an ultrasonic pulse.

### BACKGROUND

Temperature measurement methods can be divided into a contact temperature measurement method and a non-contact temperature measurement method. The contact temperature measurement method represented by thermocouple must contact with the measured medium to form heat conduction for measurement, so it will destroy the thermal equilibrium state of the measurement area, and has poor dynamic performance and low response speed, which is not conducive to the accurate real-time measurement of the local temperature, especially harsh environments such as high temperature and strong corrosion will severely affect the long-term operation or even short-term operation of contact temperature measurement. The non-contact temperature measurement method does not need to contact with the measured medium, so it will not interfere with the temperature field of the measured body, the response speed is fast, and it is suitable for medium temperature measurement in complex environments such as high temperature and strong corrosion. The commonly used non-contact temperature measurement methods mainly comprise optical temperature measurement methods, such as tunable diode laser absorption spectroscopy (TDLAS) and coherent anti-Stokes Raman scattering (CARS), and acoustic temperature measurement methods.

The optical temperature measurement method is mainly based on the spectral characteristics of molecules at different temperatures, but the optical temperature measurement method is limited by molecular components with specific spectral characteristics, and even requires a specific wavelength of laser, and the system is complex and costly.

The acoustic temperature measurement method is based on the fact that the medium of sound at different temperatures has different propagation speeds to measure, which has the advantages of a simple system, good economy and a wide application. However, the acoustic temperature measurement method uses a microphone to accept the sound, the sound needs to pass through the entire measurement area, and the measurement spatial resolution is poor, it cannot measure the temperature of a specific area and is easily affected by the boundary environment, resulting in a low measurement accuracy.

### SUMMARY

An objective of the present invention is to provide a temperature measurement method based on a laser deflection induced by an ultrasonic pulse, which can measure the temperature at any position inside the measured medium, and form a multi-dimensional temperature field reconstruction through multi-point measurement, the temperature measurement of a specific area inside the measured medium can be completed by using merely an ultrasonic generator, a simple continuous laser, and a photoelectric converter, and the maintenance of the system is simple and economical.

The present invention provides a temperature measurement method based on laser deflection induced by ultrasonic pulse, comprising the following steps:
S1, emitting a continuous laser beam by a continuous laser, and collimating the laser beam by a collimator;
S2, passing the laser beamthrough a high-temperature gas to be measured, and reflecting the laser beam into the high-temperature gas to be measured again by a high reflectivity mirror outside a measurement area;
S3, folding back and passing the laser beam through the high-temperature gas to be measured again, and then receiving the laser beam by a quadrant photodiode;
S4, arranging a pulse ultrasonic generator in a vertical direction of the laser beam, and carrying out a control by an ultrasonic generator control box;
S5, passing an ultrasonic successively through the laser beams at different distances from the pulse ultrasonic generator, and obtaining a generated deflection position information of the laser beams by the quadrant photodiode, and performing a high-speed acquisition and real-time storage of a voltage signal of the quadrant photodiode by a high-speed acquisition card and a computer;
S6, analyzing the voltage signal of the quadrant photodiode obtained by the step S5 to obtain a temperature information.

Preferably, in the step S1, the laser beam is a continuous laser.

Preferably, in the step S2, two laser beams in the high-temperature gas to be measured are kept parallel, and a distance between the two laser beams is L.

Preferably, in the step S4, a pulsed ultrasonic is configured, and an emitted ultrasonic pulse propagates vertically through the two laser beams.

Preferably, in the step S5, the ultrasonic changes a refractive index of a measured medium and interacts with an electric field of a probe laser beam to deflect the electric field of the probe laser beam proportionally to a pressure gradient of an acoustic wave.

Preferably, in the step S6, a time interval Δt of the ultrasonic passing through two laser beams successively is obtained, and a propagation velocity C of the ultrasonic in a medium between the two laser beams is calculated according to a distance L between the two laser beams; an average temperature of a cross-region of the two laser beams and the ultrasonic is calculated according to a relational expression

$$T = \frac{M \cdot {c}^{2}}{γ \cdot R}$$

between a temperature and an acoustic wave propagation velocity in the medium, where M is a molecular weight; R is an ideal gas constant; Γ is a specific heat ratio.

Therefore, the present invention adopts the above-mentioned temperature measurement method based on laser deflection induced by ultrasonic pulse, which can measure the temperature at any position inside the measured medium, and form a multi-dimensional temperature field reconstruction through multi-point measurement, the temperature measurement of a specific area inside the measured medium can be completed by using only an ultrasonic generator, a simple continuous laser, and a photoelectric converter, and the maintenance of the system is simple and economical.

Further detailed descriptions of the technical scheme of the present invention can be found in the accompanying drawings and embodiments.

### BRIEF DESCRIPTION OF THE DRAWINGS

FIG. 1 is an overall schematic diagram of a temperature measurement method based on laser deflection induced by ultrasonic pulse of the present invention;

FIG. 2 is a schematic diagram of the PD voltage pulsation formed by a laser deflection caused by ultrasonic pulses passing through the laser beam in a temperature measurement method based on laser deflection induced by ultrasonic pulse of the present invention;

FIG. 3 is an overall flow chart of a temperature measurement method based on laser deflection induced by ultrasonic pulse of the present invention.

### DETAILED DESCRIPTION OF THE EMBODIMENTS

The technical solution of the present invention will be further elaborated hereafter in conjunction with accompanying drawings and embodiments.

Unless otherwise defined, technical or scientific terms used in the present invention are to be given their ordinary meaning as understood by those of ordinary skill in the art to which the present invention belongs.

### Embodiment 1

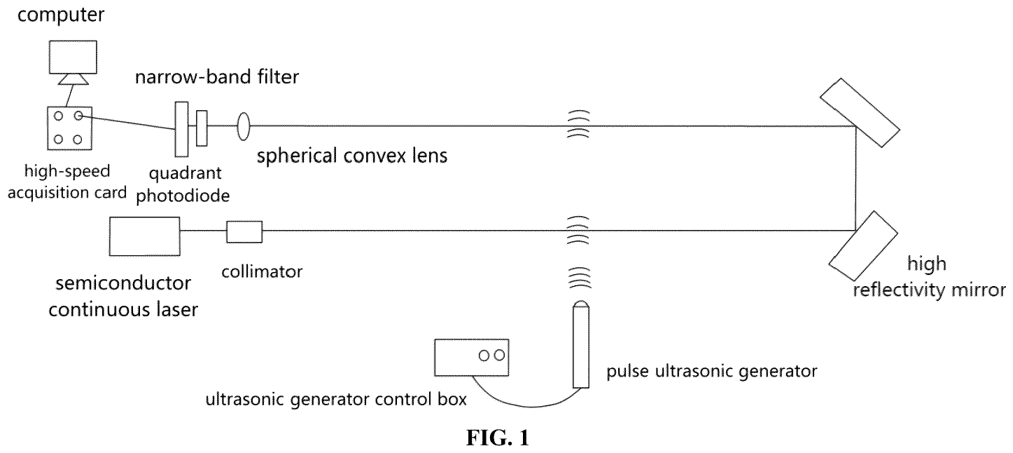

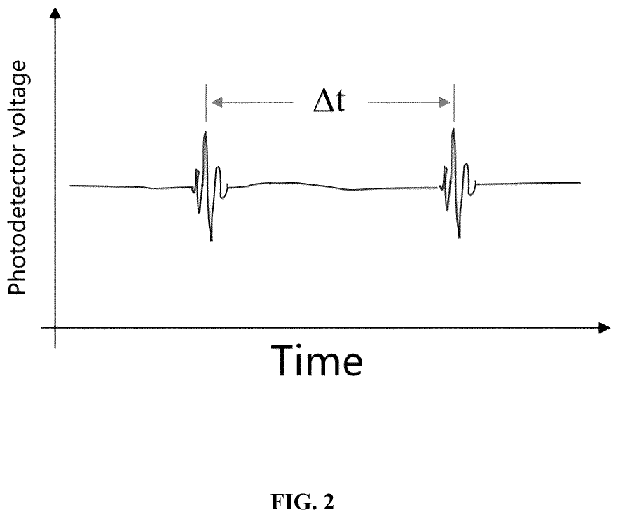

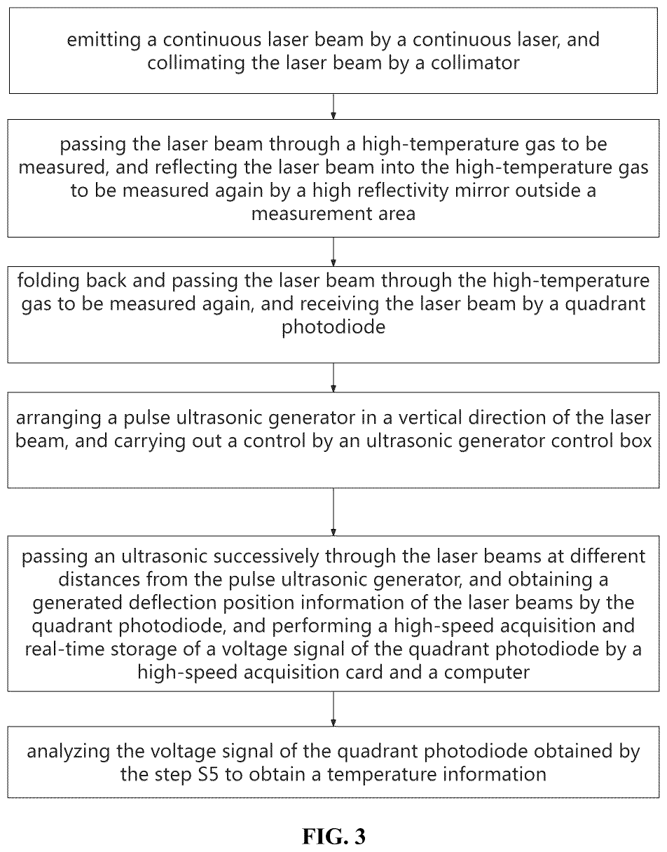

As shown in FIGS. 1-3, the present invention provides a temperature measurement method based on laser deflection induced by ultrasonic pulse, comprising the following steps:
S1, a continuous laser beam is emitted by a semiconductor continuous laser, and the laser beam is collimated by a collimator; the laser wavelength is 520 nm, and the diameter of the laser beam is 1 mm.
S2, the laser beam passes through a high-temperature gas to be measured, and the laser beam is reflected into the high-temperature gas to be measured again by a high reflectivity mirror outside a measurement area; the two lasers in the high-temperature gas to be measured are kept parallel, and the distance between the two laser beams is L.
S3, the laser beam folds back and again passes through the high-temperature gas to be measured, and then passes through a spherical convex lens and a 520 nm narrow-band filter, and finally received by a quadrant photodiode.
S4, a pulse ultrasonic generator is arranged in a vertical direction of the laser beam, and carried out control by an ultrasonic generator control box; an ultrasonic pulse frequency is 2 MHZ, and a pulse duration is 10 microseconds.
S5, the ultrasonic pulse generated by the pulse ultrasonic generator successively passes through the laser beam at different distances from the pulse ultrasonic generator, the ultrasonic changes a refractive index of the measured medium and interacts with an electric field of a probe laser beam to deflect it proportionally to the pressure gradient of the acoustic wave, and a generated deflection position information of the laser beams is obtained by the quadrant photodiode, and a high-speed acquisition and real-time storage of a voltage signal of the quadrant photodiode is performed by a high-speed acquisition card and a computer
S6, the voltage signal of the quadrant photodiode obtained by step S5 is analyzed, and a time interval Δt of the ultrasonic passing through the two laser beams successively is obtained, and a propagation velocity C of the ultrasonic in the medium between the two laser beams is calculated according to the distance L between the two laser beams; an average temperature of a cross-region of the two laser beams and the ultrasonic is calculated according to the relational expression

$$T = \frac{M \cdot {c}^{2}}{γ \cdot R}$$

between the temperature and acoustic wave propagation velocity in the medium, where M is a molecular weight; R is an ideal gas constant; T is a specific heat ratio.

Multiple parallel continuous lasers and ultrasonics are used in a cross arrangement in the propagation direction, and the cross position is the measured area; the laser beam deflection pulsation caused by the change of the refractive index of the measuring medium due to the ultrasonic pulse is measured by a photodiode; the time difference of ultrasonic pulse successively passing through different laser beams obtained by using the measured laser beam deflection pulsation, and the propagation velocity of ultrasonic in the medium between laser beams is calculated, and finally, the temperature of the medium is calculated.

Therefore, the present invention adopts the above-mentioned temperature measurement method based on laser deflection induced by ultrasonic pulse, which can measure the temperature at any position inside the measured medium, and form a multi-dimensional temperature field reconstruction through multi-point measurement, the temperature measurement of a specific area inside the measured medium can be completed by using only an ultrasonic generator, a simple continuous laser, and a photoelectric converter, and the maintenance of the system is simple and economical.

Finally, it should be noted that the above embodiments are merely used for describing the technical solutions of the present invention, rather than limiting the same. Although the present invention has been described in detail with reference to the preferred embodiments, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A temperature measurement method based on a laser deflection induced by an ultrasonic pulse, comprising the following steps:
S1, emitting a continuous laser beam by a continuous laser, and collimating the laser beam by a collimator;
S2, passing the laser beam through a high-temperature gas to be measured, and reflecting the laser beam into the high-temperature gas to be measured again by a high reflectivity mirror outside a measurement area;
S3, folding back and passing the laser beam through the high-temperature gas to be measured again, and receiving the laser beam by a quadrant photodiode;
S4, arranging a pulse ultrasonic generator in a vertical direction of the laser beam, and carrying out a control by an ultrasonic generator control box;
S5, passing an ultrasonic successively through the laser beams at different distances from the pulse ultrasonic generator, and obtaining a generated deflection position information of the laser beams by the quadrant photodiode, and performing a high-speed acquisition and real-time storage of a voltage signal of the quadrant photodiode by a high-speed acquisition card and a computer;
S6, analyzing the voltage signal of the quadrant photodiode obtained by the step S5 to obtain a temperature information.

2. The temperature measurement method based on the laser deflection induced by the ultrasonic pulse according to claim 1, wherein in the step S2, two laser beams in the high-temperature gas to be measured are kept parallel, and a distance between the two laser beams is L.

3. The temperature measurement method based on the laser deflection induced by the ultrasonic pulse according to claim 1, wherein in the step S4, a pulsed ultrasonic is configured, and an emitted ultrasonic pulse propagates vertically through two laser beams.

4. The temperature measurement method based on the laser deflection induced by the ultrasonic pulse according to claim 1, wherein in the step S5, the ultrasonic changes a refractive index of a measured medium and interacts with an electric field of a probe laser beam to deflect the electric field of the probe laser beam proportionally to a pressure gradient of an acoustic wave.

5. The temperature measurement method based on the laser deflection induced by the ultrasonic pulse according to claim 1, wherein in the step S6, a time interval Δt of the ultrasonic passing through two laser beams successively is obtained, and a propagation velocity C of the ultrasonic in a medium between the two laser beams is calculated according to a distance L between the two laser beams; an average temperature of a cross-region of the two laser beams and the ultrasonic is calculated according to a relational expression
$$T = \frac{M \cdot {c}^{2}}{γ \cdot R}$$
between a temperature and an acoustic wave propagation velocity in the medium, where M is a molecular weight; R is an ideal gas constant; Γ is a specific heat ratio.
